(19) United States
(12) Patent Application Publication
(10) Pub. No.: US 2004/0117260 A1
(43) Pub. Date: Jun. 17, 2004

(54) Point management method, management computer, computer readable recording medium, and computer data signal

(76) Inventors: Kohichi Yuasa, Tokyo (JP); Takayuki Hata, Kanagawa (JP); Takashi Mizuno, Kanagawa (JP); Sachiko Misumi, Tokyo (JP); Eiji Shinohara, Kanagawa (JP); Akihiro Kanomune, Kawasaki-shi (JP); Atsushi Hanai, Kanagawa (JP); Keisuke Kataoka, Kanagawa (JP); Maki Satoh, Kanagawa (JP); Yuuichi Fukada, Tokyo (JP)

Correspondence Address: MORRISON & FOERSTER LLP, 1650 TYSONS BOULEVARD, SUITE 300, MCLEAN, VA, 22102, US

(21) Appl. No.: 10/702,040

(22) Filed: Nov. 6, 2003

(30) Foreign Application Priority Data
Nov. 6, 2002 (JP) 2002-322531

(51) Int. Cl. G06F 17/60

(52) U.S. Cl. 705/14

(57) ABSTRACT

When a management computer accepts a request for giving points from a giving source, the management computer confirms the expiration date of points of the giving source user, by referring to a user database that stores information of the number of points that a user has, and the expiration date of the points that the user has. The management computer accepts designation of a giving number of points and giving destination user from the giving source user, in a case where the expiration date of points of the giving source user has not passed. The management computer subtracts the designated giving number of points from the number of the points of the giving source user, stored in the user database, and adds the giving number of points to the number of points of the giving destination user, stored in the user database.

### BACKGROUND OF THE INVENTION

1. Field of the Invention

The present Invention relates to a point management method and a management computer, etc., that manages points provided to a user.

2. Description of the Related Art

Conventionally, there are systems for giving points to a user (customer), when buying or selling merchandise at a store or on the Internet, as sales promotion of merchandise. An example of a system that gives points to customers is disclosed in the Unexamined Japanese Patent Application KOKAI Publication No. H11-154182. Among the point giving services, in which the object is this kind of sales promotion, there are services that enable the points held by customers to be exchanged to merchandise (gifts). The number of points necessary to exchange points to merchandise, is determined according to each merchandise. Customers can exchange points for a merchandise, in a case where the customer has the points necessary to exchange the points that the customer has with the number of points of the merchandise. There are cases where there are expiration dates of the points that are given to customers, and after the expiration date passes, the points can not be used to exchange to merchandise. In a case where the expiration date of points are set, the expiration date of points often arrives before customers obtain the necessary points for exchanging to merchandise. In this case, customers can not effectively use the points that are given to them. Therefore, purchasing inclination of customers are not roused, and sales promotion of merchandise, by point giving, can not be carried out effectively.

### SUMMARY OF THE INVENTION

In consideration of the above, an object of the present invention is to provide a point management method and a management computer, etc., that enables the users to use the points that are given to them more effectively.

Another object of the present invention is to provide a point management method and a management computer, etc., wherein the points provided to each user can be given among users.

To achieve the above objects, a point management method according to a first aspect of the present invention, manages points that are given to a user, and comprises:

a step of confirming an expiration date of points of a giving source user, after accepting a request for giving points, from the giving source user of points, by referring to a user database that stores information of the number of points that the user has and the expiration date, according to each member;

a step of accepting designation of a giving number of points and a giving destination user from the giving source user, in a case where the expiration date of points of the giving source user has not passed; and;

a step of subtracting the designated giving number of points from the number of points of the giving source user that is stored in the user database, and adding the giving number of points to the number of points of the giving destination user that is stored in the user database.

The point management method may further comprise:

a step of extracting information of a user that belongs to the same group as the group that the giving source user belongs to, from a belonging database that stores information, correlating a user and a group to which the user belongs;

a step of providing the extracted information of users to the user terminal of the giving source user, as information of candidates of being the giving destination user; and

a step of accepting a user, selected by the giving source user, from the candidates of the giving destination user, as the giving destination user.

The point management method may further comprise a step of extracting information of the group to which the giving destination user belongs, and the group to which the giving source user belongs, from the belonging database that stores information, correlating a user and a group to which the user belongs, and making giving of points possible to the giving destination user, in a case where the group to which the giving destination user belongs and the group to which the giving source user belongs, match.

The point management method may further comprise:

a step of determining whether the expiration date of points of the giving destination user has passed, by referring to the user database; and

a step of making giving of points possible to the giving destination user from the giving source user, in a case where the expiration date of the giving destination user has not passed.

A management computer according to a second aspect of the present invention is connected to a user database that stores information of the number of points that a user has and expiration date of the points that the user has, correlating it with identification information of the user, comprising:

a request receiving unit which receives a request for giving of points, including identification information of the giving source user, from a terminal, via a network;

an expiration date confirming unit which searches the user database based on the identification information of the giving source user, and confirms that the expiration date of points of the giving source member that is stored in the user database, has not passed;

a giving content receiving unit which receives information that specifies the giving number of points and giving destination user, from the terminal, via the network, in a case where it is confirmed that the expiration date of points of the giving source user has not passed; and

a point number updating unit which subtracts the giving number of points from the number of points of the giving source user that is stored in the user database, and adds the giving number of points to the number of points of the giving destination user that is stored in the user database.

the management computer may be further connected to a belonging database that stores correlating with each other, identification information of each user and group identification information of the group to which the user belongs, and the user information of each user may be further stored in the user database, and

the giving content receiving unit may:

extract identification information of users correlated with the same group identification information as the group identification information of the group, which the giving source user belongs to, from the belonging database, and extract user information that corresponds to the identification information of the extracted users, from the user database;

send the extracted user information as information of candidates of the giving destination user, to the terminal of the giving source user; and

receive from the terminal, information indicating the giving destination user, which is designated from the candidates of the giving destination user, by the giving source user.

The management computer may be further connected to a belonging database that stores identification information of users and group identification information of the group to which the user belongs, correlated with each other, and

the point number updating unit may:

extract group identification information of the group to which the giving destination user belongs and group identification information of the group to which the giving source user belongs, from the belonging database;

determine whether the extracted group identification information matches or not; and

make giving of points to the giving destination user possible, in a case where the extracted group identification information matches.

The point number updating unit may determine whether the expiration date of points of the giving destination user has passed or not, by referring to the user database, and may make giving of points from the giving source user to the giving destination user possible, in a case where the expiration date of points of the giving destination user has not passed.

A computer readable recording medium according to a third aspect of the present invention stores a program for controlling a computer to execute:

a step of receiving a request of point giving, including identification information of the giving source user, from a terminal, via a network;

a step of searching a user database that stores the number of points that a user has and the expiration date, based on the identification information of the giving source user, and confirming that the expiration date of points of the giving source user, which is stored in the user database, has not passed;

a step of obtaining information that specifies the giving number of points and the giving destination user, from the terminal, via the network, in a case where it is confirmed that the expiration date of points of the giving source user has not passed; and

a step of subtracting the giving number of points from the number of points of the giving source user, stored in the user database, and adding the giving number of points to the number of points of the giving destination user, stored in the user database.

The computer readable recording medium may store the aforementioned program for further controlling a computer to execute:

a step of extracting the identification information of the users correlated with the same group identification information as the group identification information of the group, which the giving source user belongs to, from the belonging database that stores the identification information of the users and the identification information of the group to which the user belongs, correlated with each other;

a step of extracting the user information that corresponds to the extracted identification information of the user, from the user database that further stores user information of each user;

a step of sending the extracted user information to the terminal of the giving source user, as information of candidates of the giving destination user; and

a step of receiving from the terminal, information indicating the giving destination user, selected from the candidates of the giving destination user.

The computer readable recording medium may store the aforementioned program for further controlling a computer to execute:

a step of extracting group identification information of the group to which the giving destination user belongs and the group identification information of the group to which the giving source user belongs, from the belonging database that stores, correlating with each other, identification information of the user and group identification information of the group to which the user belongs;

a step of determining whether the extracted group identification information matches; and

a step of making possible the giving of points to the giving destination user, in a case where the extracted group identification information matches.

The computer readable recording medium may store the aforementioned program for further controlling a computer to execute:

a step of determining whether the expiration date of the points of the giving destination user has passed or not, by referring to the user database; and

a step of making possible the giving of points to the giving destination user from the giving source user, in a case where the expiration date of points of the giving destination user has not passed.

A computer data signal, embedded in a carrier wave, according to a fourth aspect of the present invention, represents a program for controlling a computer, which is connected to a user database that stores correlating the number of points that a user has and information of expiration date with the identification information of the user, to execute:

a step of receiving a request for giving points, including identification information of the giving source user, from a terminal via a network;

a step of searching the user database, based on the identification information of the giving source user, and confirming that the expiration date of the points of the giving source user, stored in the user database, has not passed;

a step of obtaining information that specifies the giving number of points and the giving destination user from the terminal via the network, in a case where it is confirmed that the expiration date of the points of the giving source user has not passed; and

a step of subtracting the giving number of points from the number of points of the giving source user, stored in the user database, and adding the giving number of points to the number of points of the giving destination user, stored in the user database.

### BRIEF DESCRIPTION OF THE DRAWINGS

These objects and other objects and advantages of the present invention will become more apparent upon reading of the following detailed description and the accompanying drawings in which:

FIG. 1 is a structure diagram of a point giving system according to the present invention;

FIG. 2 is a diagram showing a structure example of a management computer;

FIG. 3 is a diagram showing an example of member information stored in a member information database;

FIG. 4 is a diagram showing an example of belonging information stored in a belonging information database;

FIG. 5 is a flowchart for describing point giving processing;

FIG. 6 is a flowchart of an expiration date checking processing by the management computer; and

FIG. 7 is a diagram showing an example of a screen output to a user terminal.

### DETAILED DESCRIPTION OF THE PREFERRED EMBODIMENT

An embodiment of the present invention will now be described with reference to the drawings. In the present embodiment, a system where points can be given to members who belong to the same company, will be described. In the present embodiment, it is assumed that the users (members) who use the point service belong to a group (in this case, a company), and there are a plurality of companies, in which a plurality of members belong to.

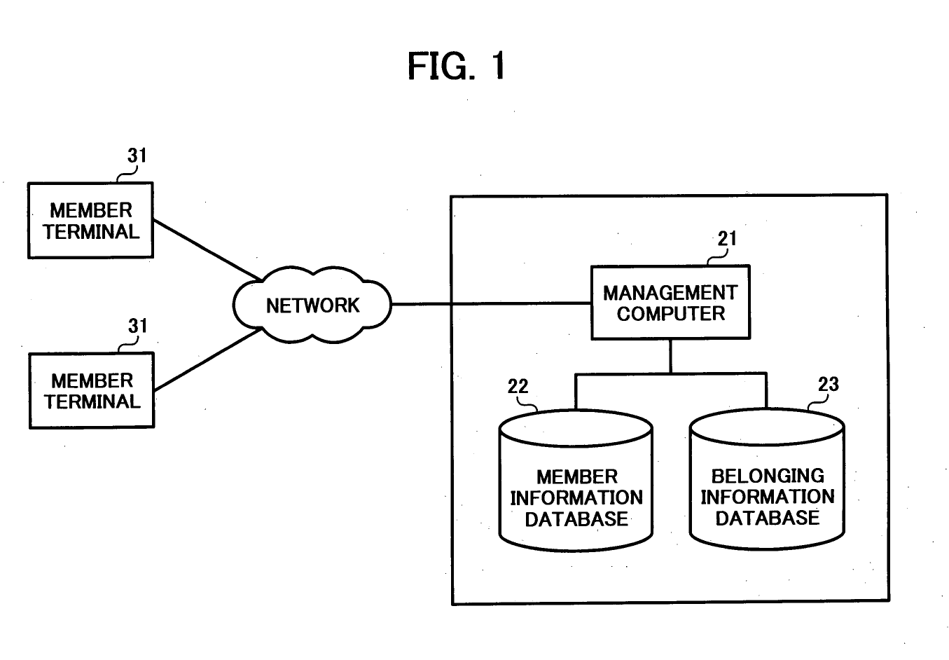

FIG. 1 is a diagram showing an example of a structure of the point giving system, according to the embodiment of the present invention. The point giving system comprises a management computer 21 and member terminals 31 that are connected to each via a network, such as the internet and the like, and a member information database 22 and a belonging information database 23 that are connected to the management computer 21 via a network, such as LAN, etc. The management computer 21, the member information database 22, and the belonging information database 23 constitute a point management system 20.

The member terminal 31 is a terminal for a member to request a giving of points, and is constituted of a computer that comprises for example, a control unit (CPU), a storing unit (RAM, ROM, hard disk, etc.), a communication unit, a display unit (for example, a monitor), and an input unit (for example, a keyboard, a mouse, etc.). By the control unit reading out various programs, etc., that are stored in the storing unit, and performing them, inputting of data, sending and receiving data between the management computer 21 in the management system 20 and the member terminal 31, and displaying of data are carried out.

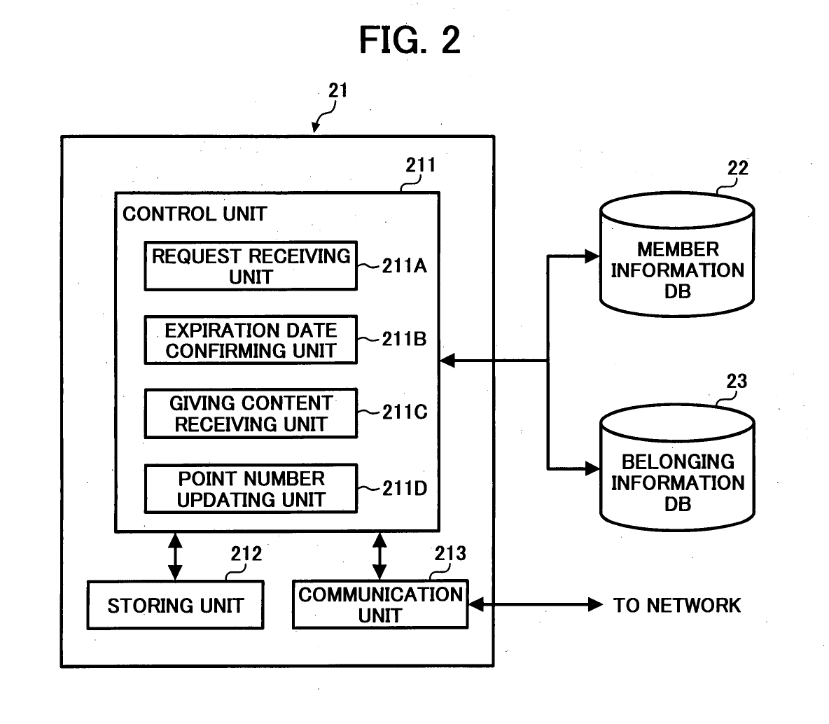

The management computer 21, as for example shown in FIG. 2, is constituted of a control unit 211, a storing unit 212, and a communication unit 213, etc. The control unit 211 is constituted of a CPU, etc., and performs processing for giving points to members who belong to the same company. Concretely, by reading out and performing various programs, etc., that are stored in the storing unit 212, the control unit 211 logically realizes, a request receiving unit 211A, an expiration date confirming unit 211B, a giving content receiving unit 211C, and a point number updating unit 211D, etc. The request receiving unit 211 A receives a request for giving points, from the member terminal 31 of the member who is to be a giving source of points. The expiration date confirming unit 211B confirms that the points of the member, who is to be a giving source of points, has not passed the expiration date, by referring to the member information database 22.

The giving content receiving unit 211C receives the designation of giving number of points and designation of giving destination, from the terminal 31 of the giving source member, in a case where the points of the giving source member have not passed the expiration date. Concretely, the giving content receiving unit 211C reads out the company code that corresponds to the member ID of the giving source member from the belonging information database 23, extracts (reads out) every member ID that correlates with the read out company code from the belonging information database 23, extracts information such as the name of member, etc., that corresponds to the extracted member ID from the belonging information database 23. The giving content receiving unit 211 C generates data of a screen that displays the extracted information such as the name of member, etc., as information indicating candidates of being a giving point destination member of points, and receives selection of inputting a giving destination member, and sends the data to the member terminal 31 of the giving source member. The giving content receiving unit 211 C receives information indicating the giving destination member that was designated (selected) by the member.

The point number updating unit 211D subtracts the number of points that are to be given (giving points) from the number of points of the giving source member, and stores the subtracted value as the number of points of the giving source member, and adds the given number of points to the number of points of the giving destination member, and stores the added value as the number of points of the giving destination member, in the member information database 22, where the number of points of each member is stored. The point number updating unit 211D determines, referring to the member information database 22, whether the expiration date of the points of the giving destination member, who was designated by the giving source member, has passed or not, and is made possible (permits) the giving of points from the giving source member to the giving destination member, in a case where the expiration date of the points of the giving destination member, stored in the member information database 22, has not passed.

The point number updating unit 211D may extract the company code of the company to which the giving destination member belongs, and the company code of the company of the company to which the giving source member belongs, from the belonging information database 23, and may determine whether the extracted company codes match. In a case where the codes match, giving of points to the giving destination member is made possible (is permitted).

The member information database 22 and the belonging information database 23 are connected to the management computer 21 by a network, such as LAN, etc.

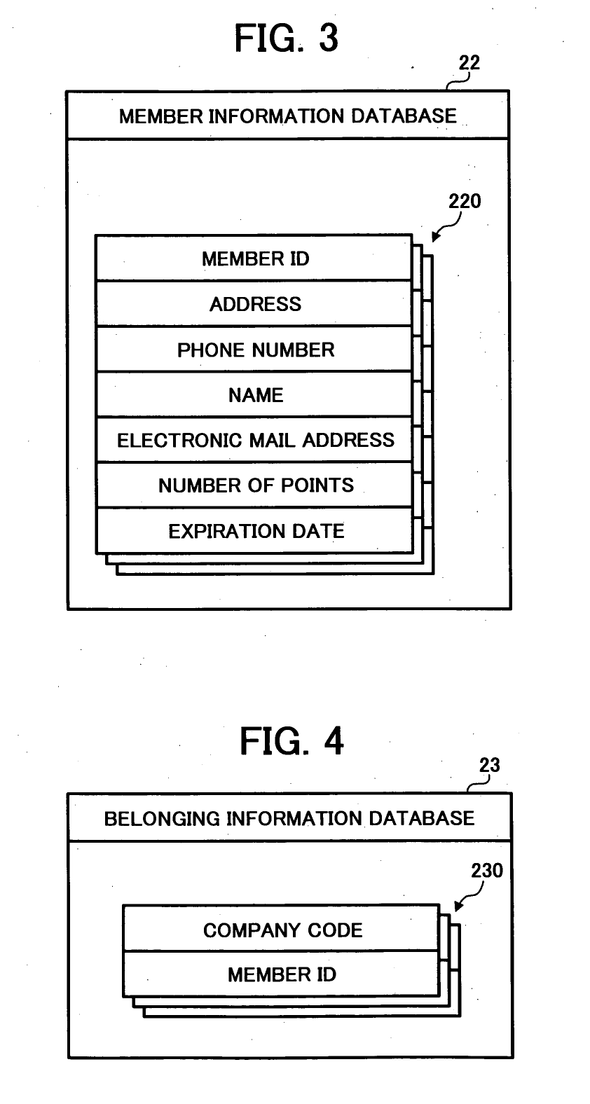

The member information database 22 is for storing information, such as the number of points that each member has and expiration date, etc. Concretely, the member information database 22 stores member information 220, for example, as shown in FIG. 3, according to each member. The member information 220 is constituted of data such as, member ID (information for identifying each member), address, phone number, name, electronic mail address, number of points, and expiration date.

The number of points in the member information 220, are the number of points that each member has, and points gained by each member is added sequentially. In the present embodiment, points are given to members, when the member purchases a merchandise that is a subject for giving points. The value of the points that are given (number of points) are added to the number of points in the member information 220 of that member. In the present embodiment, points can be exchanged to goods (gifts). In a case where points are exchanged to goods, the number of points that correspond to that goods, is subtracted from the number of points in the member information 220. The request for purchasing a merchandise, and exchange of points to goods, is performed by the member terminal 31 via a network 30. The number of points in the member information 220 is updated when a member gives points to another member, when a member is given points from another member, and when the expiration date passes, etc. The data of expiration date in the member information 220 indicates the expiration date of the points that the member obtained. The members can exchange the points to goods, until the expiration date passes. The expiration date in the member information 220 is a date that is set at a predetermined days after (for example 90 days after) the day that the member purchased a merchandise that is subject to point giving. If a merchandise that is subject to point giving is once again purchased before the set expiration date passes, a predetermined days after that day is set as the new expiration date. Namely, the expiration date is extended. The member information 220 is generated and registered before the service providing of the point giving system.

The belonging information database 23 stores belonging information 230, for example, as shown in FIG. 4, relating to members who belong to a company, according to each member. The belonging information 230 is constituted of data such as, company code, member ID, etc. The company code is for identifying the company that the members belong to. The belonging information 230 is for example, generated and registered before the service providing of the point giving system.

Next, the operation of the point giving system will be described.

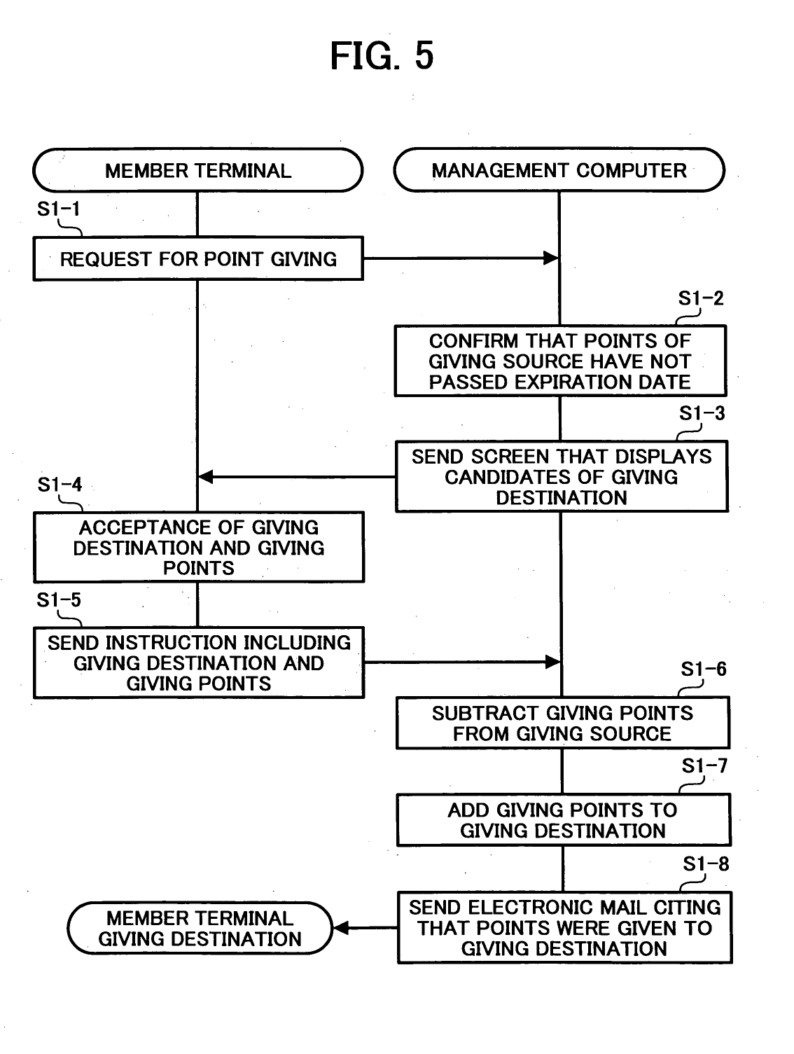

First, a point giving processing in a case where a member gives points to another member in the same company, will be described with reference to FIG. 5.

The member inputs the member ID, and carries out a predetermined input operation for requesting giving of points, applying the member terminal 31. According to the input operation, the member terminal 31 sends a display demand of the point giving screen, including the input member ID, to the management computer 21 (Step S1-1). The management computer 21 confirms that the expiration date of points of that member has not passed, when the computer receives a request from the member terminal 31 (Step S1-2). Concretely, the management computer 21 accesses to the member information database 22, specifies the member information 220 that corresponds to the member ID, and extracts data of number of points from the specified member information 220, based on the member ID received from the member terminal 31. The management computer 21 determines whether the value of number of points indicated by the extracted data is zero or not, and in a case where it is not zero, the expiration date of the points has not passed, and is decided that giving of points is possible. In a case where the number of points is zero, the management computer 21 decides that giving of points is impossible, and sends data notifying so, to the member terminal 31. As will be described later on, in a case where the expiration data set in the member information 220 has passed, the number of points in the member information 220 is set to zero. Therefore, by determining whether the number of points in the member information 220 is zero or not, it can be decided that the expiration date of points has not passed, in a case where the number of points is not zero, and giving of points after the expiration date has passed, can be prevented.

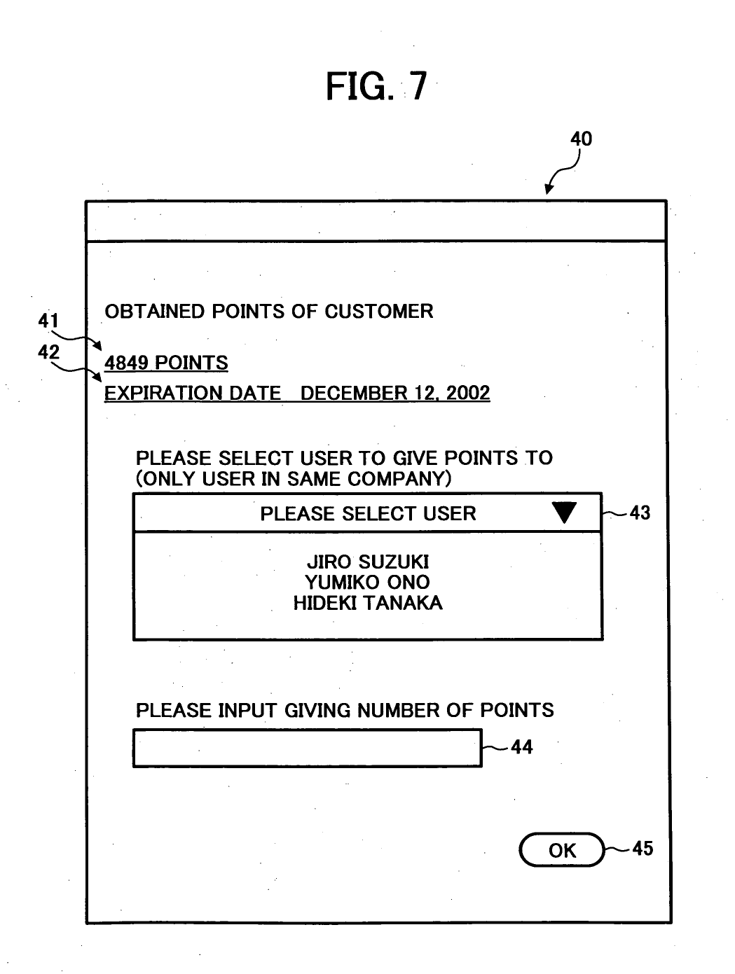

In a case where it is determined that the expiration date of points has not passed (namely, giving of points is possible), the management computer 21 generates data of a point giving screen that displays information, such as the name of members that are candidates for being the giving destination of points, and sends the data to the member terminal 31 (Step S1-3). In this embodiment, giving destinations of points are members who belong to the same company as the giving source member, and are members who can give points to other members. Concretely, the management computer 21 searches the belonging information database 23 based on the member ID included in the display demand of the point giving screen, and obtains a company code that corresponds to the member ID, namely obtains the company code of the company that the member belongs to. Then, the management computer 21 searches the belonging information database 23, applying the obtained company code, and extracts member IDs of the members who belong to the same company as the member who requested the giving of points. The management computer 21 searches the member information database 22, applying the extracted member ID, and referring to the member information 220 that corresponds, extracts data of names in the member information 220, only when the expiration date is adequately set (when the expiration date is not cleared). As will be later described, the set value in the expiration date, included in the member information 220, is deleted (cleared) when the expiration date passes. Therefore, the names of members whose points have not passed the set expiration date, are extracted. Then, the management computer 21 sends screen data that displays the names of the extracted members as candidates for being the giving destination of points (point giving screen display data) to the member terminal 31. When the member terminal 31 receives the point giving screen display data, a giving display screen 40, such as for example shown in FIG. 7 is displayed.

Number of points 41, expiration date 42, giving destination selecting box 43, giving number of points input box 44 and OK button 45, etc., are displayed on the giving display screen 40. The number of points 41 and expiration date 42 that are to be displayed, are set, based on data of the number of points and expiration date in the member information 220, concerning the member who carried out the giving request of points. In the giving destination selecting box 43, the names of the members who belong to the same company as the giving request source member, and the names of the members who can be given points, extracted by the above way, are displayed as the candidates of the point giving destination. The giving request source member can select the member for being the giving destination, from the members displayed in the giving destination selecting box 43. The number of points that are to be given, the displayed number of points 41 being the limit, are input to the giving number of points input box 44. The OK button 45 is clicked when sending data, input to the giving destination selecting box 43 and the giving number of points input box 44, to the management computer 21.

When the giving destination is selected, and the OK button 45 is clicked after the giving number of points are input, the member terminal 31 accepts point giving instructions indicating the giving content, such as the inputted giving number of points, and giving destination, etc (Step S1-4). The member terminal 31 sends the point giving instruction data that includes the designated giving destination and giving number of points, etc., to the management computer 21 (Step S1-5).

When the management computer 21 receives the point giving instruction data from the member terminal 31, the management computer 21 subtracts the giving number of points from the number of points in the member information 220 of the giving source member (Step S1-6), and adds the number of points in the member information 220 of the giving destination member (S1-7). The management computer 21 extracts the electronic mail (e-mail) address of the giving destination member from the member information database 22, and sends electronic mail citing that points have been given to the giving destination member (Step S1-8). The giving destination member receives and displays the electronic mail sent to that member, at the member terminal 31.

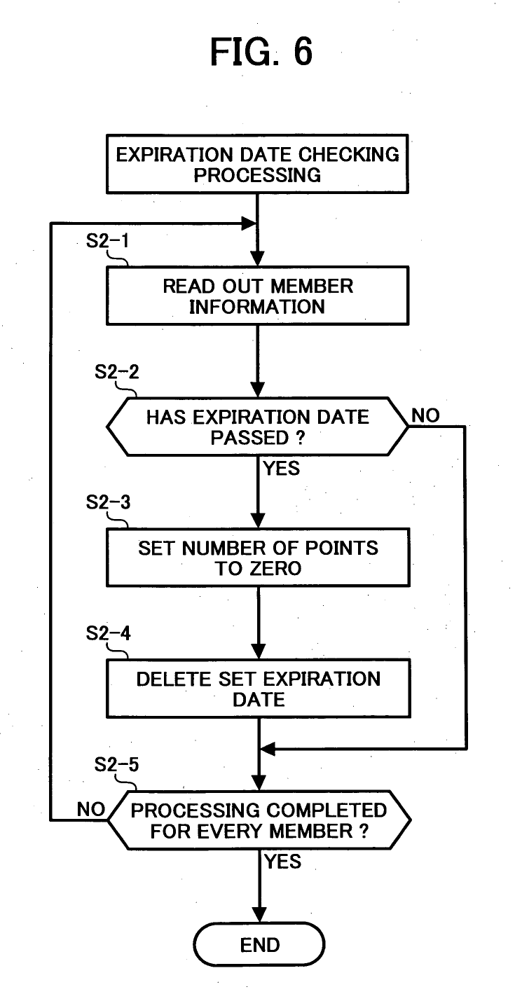

Next, expiration date checking processing by the management computer 21 that checks the expiration date of points of the members, will be described with reference to FIG. 6. As afore described, the expiration date of points is set in the member information 220, according to each member. The expiration date is set at a predetermined days after a merchandise, which is subject to provide points, is purchased, and is updated every time a merchandise subject to provide points, is purchased. The management computer 21 performs the below processing, for example every day, as the first processing of that day. For example, a not shown interior timer can be referred to, and the below processing may be performed when the pre-set time comes. By this processing, in a case where the expiration date of points set according to each member, has passed, the points can be invalidated.

First, the management computer 21 reads out the member information 220 (Step S2-1), and determines whether the expiration date has passed, comparing the expiration date in the member information 220 and the date of the current day obtained by the interior timer, etc. (Step S2-2). In a case where the expiration date has already passed (Step S2-2: YES), the number of points in the member information 220 is set to zero (Step S2-3), and the set value of the expiration date is deleted (cleared) (Step S2-4). In a case where the expiration date has not passed (Step S2-2: NO), the management computer 21 skips the processing of Steps S2-3 and S2-4. Then, the management computer 21 determines whether processing concerning every member information has been carried out (Step S2-5). In step S2-5, in a case where it is determined that the above processing concerning every member information 220 has been completed, this expiration date checking processing is completed, and in a case where it is determined that the above processing concerning every member information 220 has not been completed, the processing is returned to Step S2-1, and Steps S2-1 to S2-5 are repeated until processing concerning every member information 220 is completed (until it reaches YES at Step S2-5).

As described above, according to the present invention, the effects of below, can be gained.

In the above embodiment, the management computer 21 receives a request for giving a designated number of points, out of the number of points of the giving source member, from the giving source member to the giving destination member. The management computer 21 subtracts the designated number of points from the points of the giving source member, and adds the designated number of points to the points of the giving destination member. Therefore, the designated number of points, out of the points that the giving source member has, can be given to the giving destination member from the giving source member. The points given to the giving destination member are valid until the expiration date of points of the giving destination member (until the expiration date in the member information 220). Therefore, even if the expiration date of the giving source member passes, the points given to the giving destination member are not made invalid, and the expiration date of points can be substantially extended.

In the above embodiment, giving of points from the giving source member to the giving destination member is possible, in a case where the giving source member and the giving destination member belong to the same company. Therefore, points within the same company, can be integrated.

In the above embodiment, it is possible for the points of the giving source member to be given to members whose expiration date has not passed. Therefore, giving points to members whose expiration date has passed, can be prevented.

In the above embodiment, processing for setting the member's points to zero, in a case where the expiration date has passed, is performed for example, every day. Consequently, even if a member requests giving of points applying the member terminal 31, because the number of points is set to zero if the expiration date in the member information 220 of that member has passed, resultantly, points can not be given. Therefore, by confirming the number of points of the giving source member, the expiration date of points of the giving source member can be confirmed, and it can be set so that the members whose points have passed the expiration date, can not give points as a giving source.

In the above embodiment, giving of points to a giving destination member is possible only to members whose expiration date has not passed. However, the condition for limiting the members who can be given points, is not limited to this. For example, the condition may be that the number of points is not zero. By doing so, if the number of points in the member information 220 of the member is zero, it can be made that points are not given to that member, even if the set expiration date has not passed. In the above embodiment, by the number of points being set to zero when the expiration date in the member information 220 has passed, giving points to members whose expiration date of points has passed, can be prevented by not giving points to members whose number of points is zero.

In the above embodiment, it is determined every day, whether the expiration date has passed or not, and in a case where the expiration date has passed, the number of points in the member information 220 is set to zero. However, in a case where there is a request for giving points from the member terminal 31, determination of whether the expiration date of points has passed or not, concerning both the giving source member and the giving destination member may be determined based on information (ID), etc., that specifies the giving source member and the giving destination member, received from the member terminal 31. In this case, in a case where the expiration date of the points of the giving source member has passed, it may be that the points of that giving source member can not be given. In a case where the expiration date of points of the giving destination member has passed, it may be that points can not be given to the giving destination member. By doing so, processing of checking the expiration date of points in the member information 220 every day, and updating the number of points and the expiration date in the member information 220, which has passed the expiration date, becomes unnecessary.

In the above embodiment, the management computer 21 extracts the members who are possible to be given points, and controls the member terminal 31 to display the extracted members as candidates of the giving destination member, and has the giving source member select a giving destination member therefrom. However, the management computer 21 may have the giving source member designate a giving destination member by name or ID, etc., and the control unit 211 of the management computer may determine whether the designated member is possible to be given points to. In this case, the control unit 211 of the management computer 21 refers to the expiration date in the member information 220 of the member who is designated as the giving destination member, and by determining whether the expiration date has passed or not, determines whether the designated member is possible to be given points to. The control unit 211 of the management computer 21 may read out the company code of the company that the giving destination member belongs to and the company code of the company that the giving source member belongs to, from the belonging information database 23, and in a case where the company that the giving destination member belongs to and the company that the giving source member belongs to match, it may be that the giving of points to the giving destination member is permitted.

In the above embodiment, giving of points among members who belong to the same company is possible. However, groups are not limited to “companies”, and are arbitrary. For example, groups may be “families”. In this case, by correlating a family code that identifies the family with a member ID, and registering the information in the belonging information database 23, giving of points within the family can be possible.

In the above embodiment, giving of points is possible among members who belong to the same company. However, the giving destination of points does not have to be limited to a case where the giving destination member belongs to the same group as the giving source member. By doing so, inter-group integration of points can be possible.

In the above embodiment, in a case where points are given from a giving source member to a giving destination member, the expiration date of points of the giving destination member stays the same. However, the management computer 21 may determine whether the expiration date of points of the giving source member is later than the expiration date of points of the giving destination member, and in a case where it is after, the expiration date of points in the member information 220 of the giving destination member may be set to the expiration date of the points in the member information 220 of the giving source member. By doing so, in a case where the expiration date of points of the giving destination member is earlier than the expiration date of point of the giving source member, and it is desired to integrate points to the giving destination member, the expiration date of points can substantially be extended, applying the expiration date of the giving source member.

In the above embodiment, the management computer 21 received giving requests from the terminal 31, via the network 30, such as the Internet, etc. However, the network 30 in the present invention, is not limited to the Internet. A dedicated apparatus may be applied instead of the member terminal 31, to perform the same processing.

As described above, according to the present invention, points given to users, can be utilized more usefully.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-322531 filed on Nov. 6, 2002, and including specification, claims, drawings and summary. The disclosure of the above Japanese Patent Application is incorporated herein by reference in its entirety.

What is claimed is:

1. A point management method that manages points that are given to a user, comprising:
a step of confirming an expiration date of points of a giving source user, after accepting a request for giving points from the giving source user of points, by referring to a user database that stores information of the number of points that the user has and the expiration date, according to each member;
a step of accepting designation of a giving number of points and a giving destination user from the giving source user, in a case where the expiration date of points of the giving source user has not passed; and;
a step of subtracting the designated giving number of points from the number of points of the giving source user that is stored in said user database, and adding the giving number of points to the number of points of the giving destination user that is stored in said user database.

2. The point management method according to claim 1, further comprising:
a step of extracting information of a user that belongs to the same group as the group that the giving source user belongs, from a belonging database that stores information, correlating a user and a group to which the user belongs;
a step of providing the extracted information of users to the user terminal of the giving source user, as information of candidates of being the giving destination user; and
a step of accepting a user, selected by the giving source user, from the candidates of the giving destination user, as the giving destination user.

3. The point management method according to claim 1, further comprising a step of extracting information of the group to which the giving destination user belongs and the group to which the giving source user belongs, from the belonging database that stores information, correlating a user and a group to which the user belongs, and making giving of point possible to the giving destination user, in a case where the group to which the giving destination user belongs and the group to which the giving source user belongs match.

4. The point management method according to claim 1, further comprising:
a step of determining whether the expiration date of points of the giving destination user has passed, by referring to said user database; and
a step of making giving of points possible to the giving destination user from the giving source user, in a case where the expiration date of the giving destination user has not passed.

5. A management computer that is connected to a user database that stores information of the number of points that a user has and expiration date of the points that the user has, correlating it with identification information of the user, comprising:
a request receiving unit which receives a request for giving of points, including identification information of the giving source user, from a terminal, via a network;
an expiration date confirming unit which searches the user database based on the identification information of the giving source user, and confirms that the expiration date of points of the giving source member that is stored in the user database, has not passed;
a giving content receiving unit which receives information that specifies the giving number of points and giving destination user, from said terminal, via said network, in a case where it is confirmed that the expiration date of points of the giving source user has not passed; and
a point number updating unit which subtracts the giving number of points from the number of points of the giving source user that is stored in said user database, and adds the giving number of points to the number of points of the giving destination user that is stored in said user database.

6. The management computer according to claim 5, wherein, said management computer is further connected to a belonging database that stores identification information of each user and group identification information of the group to which the user belongs, and the user information of each user is further stored in said user database, and
said giving content receiving unit:
extracts identification information of users correlated with the same group identification information as the group identification information of the group, which the giving source user belongs to, from said belonging database, and extracts user information that corresponds to the identification information of the extracted users, from said user database;
sends the extracted user information as information of candidates of the giving destination user, to the terminal of the giving source user; and
receives from said terminal, information indicating the giving destination user, which is designated from the candidates of the giving destination user, by the giving source user.

7. The management computer according to claim 5, wherein said management computer is further connected to a belonging database that stores identification information of users and group identification information of the group to which said user belongs, correlated with each other, and
said point number updating unit:
extracts group identification information of the group to which the giving destination user belongs and group identification information of the group to which the giving source user belongs, from said belonging database;
determines whether the extracted group identification information matches or not; and
makes giving of points to the giving destination user possible, in a case where the extracted group identification information matches.

8. The management computer according to claim 5, wherein said point number updating unit determines whether the expiration date of points of the giving destination user has passed or not, by referring to said user database, and makes giving of points from the giving source user to the giving destination user possible, in a case where the expiration date of points of the giving destination user has not passed.

9. A computer readable recording medium that stores a program for controlling a computer to execute:
a step of receiving a request of point giving, including identification information of the giving source user, from a terminal, via a network;
a step of searching a user database that stores the number of points that a user has and the expiration date, based on the identification information of the giving source user, and confirms that the expiration date of points of the giving source user, which is stored in the user database, has not passed;
a step of obtaining information that specifies the giving number of points and the giving destination user, from said terminal, via said network, in a case where it is confirmed that the expiration date of points of the giving source user has not passed; and
a step of subtracting the giving number of points from the number of points of the giving source user, stored in the user database, and adding the giving number of points to the number of points of the giving destination user, stored in the user database.

10. The computer readable recording medium according to claim 9, that stores said program for further controlling a computer to execute:
a step of extracting the identification information of the users correlated with the same group identification information as the group identification information of the group, which the giving source user belongs to, from the belonging database that stores the identification information of the users and the identification information of the group to which the user belongs, correlated with each other;
a step of extracting the user information that corresponds to the extracted identification information of the user, from the user database that further stores user information of each user;
a step of sending the extracted user information to the terminal of the giving source user, as information of candidates of the giving destination user; and
a step of receiving from said terminal, information indicating the giving destination user, selected from the candidates of the giving destination user.

11. The computer readable recording medium according to claim 9, that stores said program for further controlling a computer to execute a step of:
extracting group identification information of the group to which the giving destination user belongs and the group identification information of the group to which the giving source user belongs, from the belonging database that stores, correlating with each other, identification information of the user and group identification information of the group to which the user belongs;
determining whether the extracted group identification information matches; and
making possible the giving of points to the giving destination user, in a case where the extracted group identification information matches.

12. The computer readable recording medium according to claim 9, that stores said program for further controlling a computer to execute:
a step of determining whether the expiration date of the points of the giving destination user has passed or not, by referring to the user database; and
a step of making possible the giving of points to the giving destination user from the giving source user, in a case where the expiration date of points of the giving destination user has not passed.

13. A computer data signal, embedded in a carrier wave, and representing a program for controlling a computer, which is connected to a user database that stores correlating, the number of points that a user has and information of expiration date with the identification information of the user, to execute:
a step of receiving a request for giving points, including identification information of the giving source user, from a terminal via a network;
a step of searching the user database, based on the identification information of the giving source user, and confirming that the expiration date of the points of the giving source user, stored in the user database has not passed;
a step of obtaining information that specifies the giving number of points and the giving destination user from said terminal via said network, in a case where it is confirmed that the expiration date of the points of the giving source user has not passed; and
a step of subtracting the giving number of points from the number of points of the giving source user, stored in the user database, and adding the giving number of points to the number of points of the giving destination user, stored in the user database.
